(19) United States
(12) Patent Application Publication
(10) Pub. No.: US 2022/0190526 A1
(43) Pub. Date: Jun. 16, 2022

(54) Connector

(71) Applicant: Tyco Electronics (Shanghai) Co. Ltd., Shanghai (CN)

(72) Inventors: Hua He, Shanghai (CN); Yong (Chris) Wang, Shanghai (CN); Yingchun (David) Wang, Shanghai (CN); Haibo (Robert) Gan, Shanghai (CN); Yuquan (Kenny) Chen, Shanghai (CN)

(73) Assignee: Tyco Electronics (Shanghai) Co. Ltd., Shanghai (CN)

(21) Appl. No.: 17/551,764

(22) Filed: Dec. 15, 2021

(30) Foreign Application Priority Data
Dec. 15, 2020 (CN) 20202299909.1

(51) Int. Cl. H01R 13/6585; H01R 13/622

(52) U.S. Cl. CPC H01R 13/6585; H01R 13/622

(57) ABSTRACT

A connector includes a metal shell, and an insulation body received in the metal shell and formed with a slot. First and second terminal openings are provided in the insulation body and are separated by a metal sheet inserted into the slot of the insulation body.

### CROSS-REFERENCE TO RELATED APPLICATIONS

This application claims the benefit of Chinese Patent Application No. CN 202022999009.1 filed on Dec. 15, 2020 in the State Intellectual Property Office of China, the whole disclosure of which is incorporated herein by reference.

### FIELD OF THE INVENTION

The present invention relates to electrical connectors, and more particularly, to an electrical connector having an electromagnetic interference shield.

### BACKGROUND

In the prior art, in order to improve the performance of an electrical connector, it is often necessary to provide a metal shielding shell for blocking undesired electromagnetic interference. The shielding shell is typically sheathed on the insulation body, and the terminals of the connector are inserted in the insulation body and surrounded by shell for shielding the signal terminal of the connector from external electromagnetic interference. However, for a connector with both power and signal terminals, the power terminal may still generate interference which affects the signal terminal. This can reduce signal transmission quality to below desired and/or required levels.

Accordingly, improved solutions for reducing electromagnetic interference are desired.

### SUMMARY

According to an embodiment of the present disclosure, a connector includes a metal shell, and an insulation body received in the metal shell and formed with a slot. First and second terminal openings are provided in the insulation body and are separated by a metal sheet inserted into the slot of the insulation body.

### BRIEF DESCRIPTION OF THE DRAWINGS

The invention will now be described by way of example with reference to the accompanying Figures, of which:

FIG. 1 is an illustrative perspective view of a connector according to an exemplary embodiment of the present invention;

FIG. 2 is an illustrative perspective view of a metal sheet of the connector shown in FIG. 1;

FIG. 3 is an illustrative view of inserting the metal sheet of the connector into the slot of the insulation body; and

FIG. 4 is an illustrative perspective view of the insulation body with the inserted metal sheet.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to embodiments of the present disclosure, a connector includes a metal shell having an insulation body received therein. The insulation body includes a signal terminal and a power terminal arranged therein, and defines a slot for receiving a metal sheet for separating the signal terminal from the power terminal. The metal sheet includes elastic contact features formed on both sides thereof for elastically and electrically contacting an inner wall of the metal shell when inserted within the slot of the insulation body.

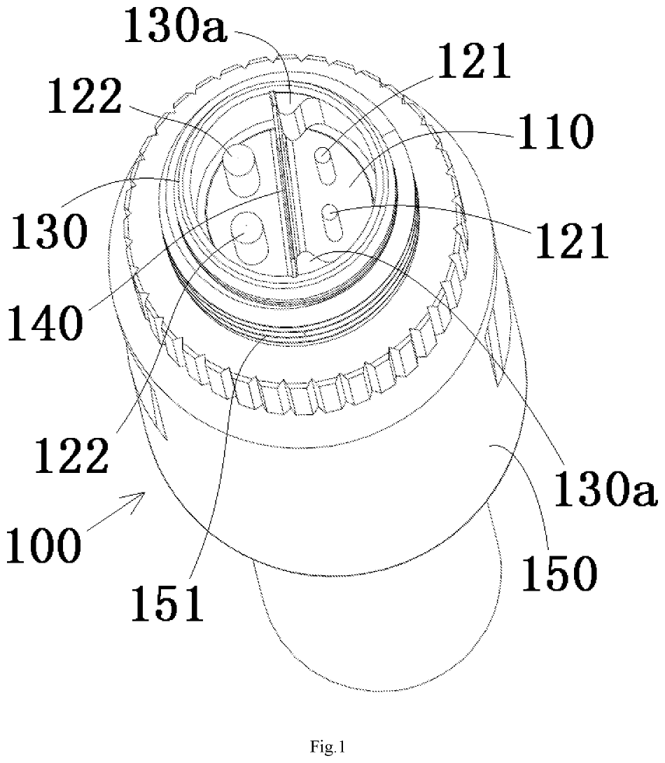

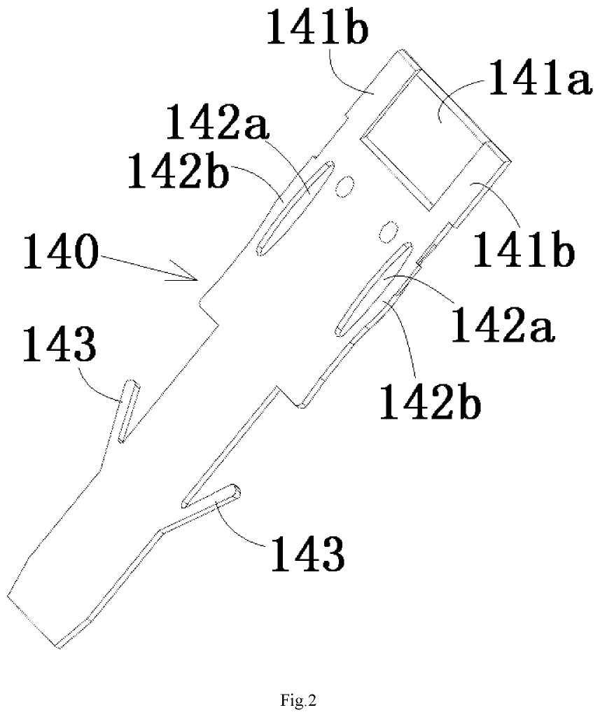

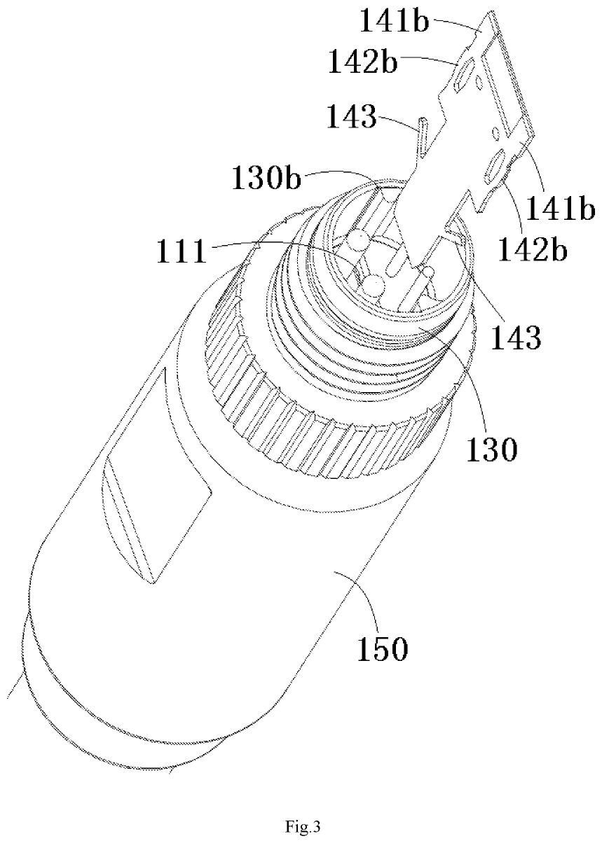

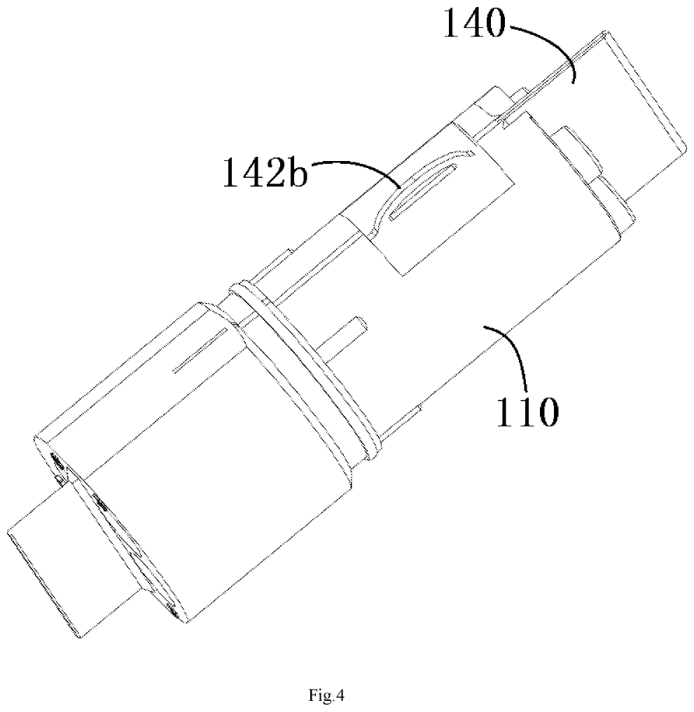

FIG. 1 is a perspective view of a connector 100 according to an exemplary embodiment of the present invention. FIG. 2 is an illustrative perspective view of a metal sheet 140 of the connector 100 shown in FIG. 1. FIG. 3 is an illustrative view of inserting the metal sheet 140 of the connector 100 into the slot 111 of the insulation body 110. FIG. 4 is an illustrative perspective view of the insulation body 110 with the inserted metal sheet 140.

As shown in FIGS. 1-4, in an embodiment, the connector mainly comprises a metal shell 130, an insulation body 110, a signal terminal 121, a power terminal 122, and a metal sheet 140. The insulation body 110 is received in the metal shell 130 and formed with a slot 111. The signal terminal 121 is provided in the insulation body 110. The power terminal 122 is provided in the insulation body 110. The metal sheet 140 is inserted into the slot 111 of the insulation body 110 for separating the signal terminal 121 from the power terminal 122. Elastic contact features are formed on both sides of the metal sheet 140, and the elastic contact features are in elastic electrical contact with an inner wall of the metal shell 130.

When the metal sheet 140 is inserted into the slot 111 of the insulation body 110, the elastic contact features on both sides of the metal sheet 140 are respectively in elastic electrical contact with the inner wall of the metal shell 130. In this way, the inner space of the metal housing 130 can be separated into two electromagnetic shielding spaces with closed magnetic circuits, thus effectively preventing the signal terminal 121 from being interfered by the power terminal 122.

As shown in FIGS. 2-4, in an embodiment, the elastic contact feature comprises an arc-shaped elastic arm 142b. Two ends of the arc-shaped elastic arm 142b are connected to a main body part of the metal sheet 140, and the middle part of the arc-shaped elastic arm 142b protrudes outwards to elastically and electrically contact with the inner wall of the metal shell 130. In an embodiment, a slot hole or opening 142a is formed between the arc-shaped elastic arm 142b and the main body part of the metal sheet 140 to allow the arc-shaped elastic arm 142b to be elastically deformed towards the slot hole 142a when pressed. In an embodiment, the slot hole 142a is oval, and the size of the slot hole 142a is gradually reduced from the middle part to each end of the arc elastic arm 142b. In an embodiment, the arc-shaped elastic arms 142b are close to an outer end of the metal sheet 140, and the arc-shaped elastic arms 142b on the metal sheet 140 are symmetrically arranged on both sides of the metal sheet 140.

As shown in FIGS. 2 and 3, in an embodiment, the metal sheet 140 also comprises a pair of elastic cantilevers 143. A fixed end of the elastic cantilever 143 is connected to the main body part of the metal sheet 140, and a free end of the elastic cantilever 143 extends outwards obliquely. The elastic cantilever 143 is in a barbed shape to prevent the inserted metal sheet 140 from being pulled out of the insulation body 110. In the illustrated embodiment, the elastic cantilever 143 does not extend from the insulation body 110, but the present invention is not limited to this, and the elastic cantilever 143 may extend from the insulation body 110 to elastically and electrically contact with the inner wall of the metal shell 130. In an embodiment, the elastic cantilever 143 is close to an inner end of the metal sheet 140, and the pair of elastic cantilevers 143 on the metal sheet 140 are symmetrically arranged on both sides of the metal sheet 140.

As shown in FIGS. 1-4, in an embodiment, the outer end 141a, 141b of the metal sheet 140 is exposed to the outside of the insulation body 110 for electrical contact with a mating metal sheet of a mating connector. In an embodiment, the outer end 141a, 141b of the metal sheet 140 includes a middle region 141a and side regions 141b on both sides of the middle region 141a. The thickness of the side regions 141b of the outer end 141a, 141b is greater than that of the middle region 141a of the outer end 141a, 141b.

In an embodiment, the middle region 141a of the outer end 141a, 141b is used as an electrical contact area for electrical contact with the mating metal sheet of the mating connector. The side regions 141b of the outer end 141a, 141b are used as an operation part for inserting the metal sheet 140. Therefore, the metal sheet 140 may be inserted into the insulation body 110 by pushing the side regions 141.

In an embodiment, a guide groove 130b matched with a side edge of the metal sheet 140 is formed on the inner wall of the metal shell 130 to guide the metal sheet 140 to be inserted into the slot 111 of the insulation body 110. As shown in FIG. 4, in the illustrated embodiment, the metal sheet 140 may penetrate the slot 111 on the insulation body 110 along the axial direction of the insulation body 110.

In the exemplary embodiment, the slot 111 in the insulation body 110 is located in a plane passing through the central axis of the insulation body 110. Two rib protrusions 130a are formed on the inner wall of the metal shell 130. The two rib protrusions 130a extend along a direction parallel to an axis of the metal shell 130 and are opposite to each other in a radial direction of the metal shell 130. Two positioning grooves corresponding to the two rib protrusions 130a are formed on the outer wall of the insulation body 110. The two rib protrusions 130a are respectively positioned in the two positioning grooves.

In an embodiment, the connector 100 is a plug connector, and the connector 100 further comprises a metal outer sleeve 150 sheathed on the metal shell 130. A threaded part 151 suitable for threaded connection with the mating connector is formed on the metal outer sleeve 150.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a metal shell;
an insulation body received in the metal shell and formed with a slot;
a first terminal opening provided in the insulation body;
a second terminal opening provided in the insulation body; and
a metal sheet inserted into the slot of the insulation body for separating the first terminal opening from the second terminal opening.

2. The connector of claim 1, further comprising at least one elastic contact feature arranged between the metal sheet and an inner wall of the metal shell.

3. The connector of claim 2, wherein the metal sheet defines a pair of elastic contact features, each elastic contact feature formed on a lateral side of the metal sheet.

4. The connector according to claim 3, wherein each elastic contact feature includes an arc-shaped elastic arm, two ends of the arc-shaped elastic arm are connected to a main body part of the metal sheet, and a middle part of the arc-shaped elastic arm protrudes outwards to elastically and electrically contact the inner wall of the metal shell.

5. The connector according to claim 4, wherein an opening is formed between the arc-shaped elastic arm and the main body part of the metal sheet to allow the arc-shaped elastic arm to be elastically deformed towards the slot hole.

6. The connector according to claim 5, wherein the opening is oval, and the size of the opening is gradually reduced from the middle part to each end of the arc-shaped elastic arm.

7. The connector according to claim 4, wherein the arc-shaped elastic arms are positioned proximate an outer end of the metal sheet, and the arc-shaped elastic arms symmetrically arranged on both sides of the metal sheet.

8. The connector according to claim 4, wherein the metal sheet further includes a pair of elastic cantilevers, a fixed end of the elastic cantilever is connected to the main body part of the metal sheet, and a free end of the elastic cantilever extends obliquely outwards and preventing the inserted metal sheet from being pulled out of the insulation body.

9. The connector according to claim 8, wherein the elastic cantilever extends from the insulation body to elastically and electrically contact the inner wall of the metal shell.

10. The connector according to claim 8, wherein the elastic cantilever is formed proximate an inner end of the metal sheet, and the pair of elastic cantilevers on the metal sheet are symmetrically arranged on both sides of the metal sheet.

11. The connector according to claim 1, wherein an outer end of the metal sheet is exposed outside of the insulation body for electrically contacting a mating metal sheet of a mating connector.

12. The connector according to claim 11, wherein the outer end of the metal sheet includes a middle region and side regions on both sides of the middle region, the thickness of the side regions of the outer end is greater than that of the middle region of the outer end.

13. The connector according to claim 12, wherein the middle region of the outer end define an electrical contact area for electrically contacting with the mating metal sheet of the mating connector, the metal sheet is inserted into the insulation body by applying a force on the side regions.

14. The connector according to claim 1, wherein a guide groove matched with a side edge of the metal sheet is formed on the inner wall of the metal shell to guide the metal sheet to be inserted into the slot of the insulation body.

15. The connector according to claim 1, wherein the slot in the insulation body is located in a plane passing through a central axis of the insulation body.

16. The connector according to claim 1, further comprising:
two rib protrusions formed on an inner wall of the metal shell, the rib protrusions extend along a direction parallel to an axis of the metal shell and are oriented opposite to each other in a radial direction of the metal shell; and
two positioning grooves corresponding to the two rib protrusions formed on an outer wall of the insulation body, the two rib protrusions respectively positioned in the two positioning grooves.

17. The connector according to claim 1, further comprising a threaded metal outer sleeve sheathed on the metal shell for threadably connecting to a mating connector.

18. A connector, comprising:
a conductive shell;
an insulation body received in the shell and formed with a slot;
a signal terminal provided in the insulation body;
a power terminal provided in the insulation body; and
a metal sheet inserted into the slot of the insulation body for separating the signal terminal from the power terminal, the metal sheet held within the slot via elastic electrical contact with an inner wall of the shell.

19. The connector of claim 18, wherein the metal sheet defines:
an arc-shaped elastic arm formed a side of the metal sheet for elastically and electrically contacting the inner wall of the shell, an end of the arc-shaped elastic arm connected to a main body part of the metal sheet, and a middle part of the arc-shaped elastic arm protrudes outwards to elastically and electrically contact with the inner wall of the shell; and
an elastic cantilever, a fixed end of the elastic cantilever is connected to the main body part of the metal sheet, and a free end of the elastic cantilever extends obliquely outwards for preventing the inserted metal sheet from being pulled out of the insulation body.

20. The connector according to claim 18, wherein an outer end of the metal sheet, an outer end of the signal terminal, and an outer end of the power terminal are exposed outside of a first end of the insulation body for electrically contacting a mating metal sheet, a mating signal terminal, and a mating power terminal of a mating connector.
